(19) United States
(12) Patent Application Publication
(10) Pub. No.: US 2011/0295702 A1
(43) Pub. Date: Dec. 1, 2011

(54) METHOD AND SYSTEM FOR MANAGING AND LINKING USER ACCOUNTS

(76) Inventors: Roop Kumar Bhadury, Eastern Heights (AU); Derek McDonald, Jimboomba (AU); Dev Mayur Zaveri, Robertson (AU)

(21) Appl. No.: 13/117,031

(22) Filed: May 26, 2011

Related U.S. Application Data
(60) Provisional application No. 61/348,644, filed on May 26, 2010.

(51) Int. Cl. G06Q 30/00

(52) U.S. Cl. 705/14.73

(57) ABSTRACT

A method and system for managing and linking user accounts is disclosed. According to one embodiment, a first user sends a request for account linking containing a username of a second user. The request is sent to the second user, and in response to the request, the second user approves or denies the request from the first user. The approval or denial response is sent back to the first user. With the approval from the second user, the first user and the second user are linked, and the first user and the second user are allowed to share access to web pages, content, ads and/or revenue based on performance of the second user and/or the first user.

The present application claims the benefit of the earlier filing date of U.S. Provisional patent application No. 61/348,644 entitled “User Account Linking” and filed on May 26, 2010, which is hereby incorporated by reference in its entirety.

### FIELD

The field of the invention relates generally to computer systems. In particular, the present method and system is directed to user account management in various servers and agencies.

### BACKGROUND

Advertisers who do not have enough online presence or wish to run an online campaign pay publishers to promote their or their customer's products and services. Online publishers and advertisers provide various ways to increase website traffic and visitors for promoting sales on their websites. The currently available web advertising and tracking mechanisms such as pay-per-click, pay-per-impression, pay-per-join, pay-per-email, help online advertisers to promote their services or products and publishers hosting such web sites collect fees based on their trafficking performance.

Typically, advertisers runs an ad campaign through publishers' web sites based on a fee agreement. The advertisement hosting publishers get paid by the advertisers based on the number of users exposed to the campaign, different levels of activities of users react to the campaigns, etc. Ad campaigns run on various media and content delivery system including Internet web sites, mobile applications, as well as more general advertising content delivery mechanisms such as banner ads, towers, skyscrapers, video ads, overlays and interstitials, among others.

The present invention employs a permission-based account linking mechanism between advertisers, publishers, and agencies to provide benefits and solutions for efficient account linking, ad and content targeting and management.

### SUMMARY

A method and system for managing and linking user accounts is disclosed. According to one embodiment, a first user sends a request for account linking containing a username of a second user. The request is sent to the second user, and in response to the request, the second user approves or denies the request from the first user. The approval or denial response is sent back to the first user. With the approval from the second user, the first user and the second user are linked, and the first user and the second user are allowed to share access to specific web pages, content, ads and/or revenue based on performance of the second user and/or the first user.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIGS. 1A-1B illustrate a flow chart of an exemplary account linking process, according to one embodiment;

FIG. 2 illustrates exemplary account types and linking structure, according to one embodiment; and

FIG. 3 illustrates an exemplary computer architecture for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A method and system for managing and linking user accounts is disclosed. According to one embodiment, a first user sends a request for account linking containing a username of a second user. The request is sent to the second user, and in response to the request, the second user approves or denies the request from the first user. The approval or denial response is sent back to the first user. With the approval from the second user, the first user and the second user are linked, and the first user and the second user are allowed to share access to web pages, content, ads and/or revenue based on performance of the second user and/or the first user.

In one embodiment, the first user is an advertiser and the second user is a publisher. Once a link between the advertiser and the publisher is established, the publisher can ‘share’ access to specific panels on their website with the linked advertiser, allowing for fine-grained ad targeting. By the same token, the advertiser can share their ads and content with the linked publisher, allowing them to direct place ads and content on their website through a user viewing element.

The present application is related to U.S. Patent Application entitled “End User Viewable Web Element” by Roop Kumar Bhadbury and Dev Mayur Zaveri, filed on May 6, 2011; U.S. Patent Application entitled “Advertising and Mobile Site Builder” by Roop Kumar Bhadbury, Mark Brown, Derek McDonald, and Dev Mayur Zaveri, filed on May 26, 2011; and U.S. Patent Application entitled “Content and Application Serving Mechanism” by Roop Kumar Bhadbury, Derek McDonald, and Dev Mayur Zaveri, filed on May 26, 2011, the entire contents of which are incorporated herein by reference.

Each of the features and teachings disclosed herein can be utilized separately or in conjunction with other features and teachings to provide a method and system for providing asynchronous data communication in a networked environment. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some terms are defined below in alphabetical order for easy reference. These terms are not rigidly restricted to these definitions. A term may be further defined by its use in other sections of this description.

“Ad/advertisement” means a commercial message targeted to an advertiser's customer or prospect.

“Ad banner” means a graphical image or other type of media object used as an advertisement.

“Ad impression” means 1) an advertisement that is served to a user's browser. Ads can be requested by the user's browser (also referred to as pulled ads) or they can be pushed, such as email ads; 2) a measurement of responses from an ad delivery system to an ad request from the user's browser that is filtered from robotic activity and is recorded at a point as late as possible in the process of delivery of the creative material to the user's browser.

“Database” means a collection of data organized in such a way that a computer program may quickly select desired pieces of the data. A database is an electronic filing system. In some implementations, the term “database” may be used as shorthand for “database management system”.

“Device” means software, hardware or a combination thereof. A device may sometimes be referred to as an apparatus. Examples of a device include without limitation a software application such as Microsoft Word®, a laptop computer, a database, a server, a display, a computer mouse, a mobile device, a tablet device and a hard disk. Each device is configured to carry out one or more steps of the method of storing an internal identifier in metadata.

“Link” means an association with an object or an element in memory. A link is typically a pointer. A pointer is a variable that contains the address of a location in memory. The location is the starting point of an allocated object, such as an object or value type, or the element of an array. The memory may be located on a database or a database system. “Linking” means associating with (e.g., pointing to) an object in memory.

“Microsite/micro website” generally means a website containing an individual web page or a small cluster pages mean to function as an auxiliary supplement to a primary website. Often, microsites are used for editorial purposes by a commercial business to add editorial value. Microsites may be used for purely commercial purposes to create in-depth information about a particular product, service or as editorial support towards a specific product, such as describing a new technology.

“Metadata” generally means data that describes data. More particularly, metadata may be used to describe the contents of digital recordings. Such metadata may include, for example, a track name, a song name, artist information (e.g., name, birth date, discography), album information (e.g., album title, review, track listing, sound samples), relational information (e.g., similar artists and albums, genre) and/or other types of supplemental information. Conventional optical discs (e.g., CDs, DVDs, Blu-ray Discs) do not typically contain metadata. Metadata may be associated with a digital recording (e.g., song, album, movie or video) after the digital recording has been ripped from an optical disc, converted to another digital audio format and stored on a hard drive.

“Network” means a connection between any two or more computers, which permits the transmission of data. A network may be any combination of networks, including without limitation the Internet, a local area network, a wide area network, a wireless network and a cellular network.

“Server” means a software application that provides services to other computer programs (and their users), in the same or other computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“System” means a device or multiple coupled devices. A device is defined above.

“User” means a consumer, client, and/or client device in a marketplace of products and/or services.

“User device” (e.g., “client”, “client device”, “user computer”) is a hardware system, a software operating system and/or one or more software application programs. A user device may refer to a single computer or to a network of interacting computers. A user device may be the client part of a client-server architecture. A user device typically relies on a server to perform some operations. Examples of a user device include without limitation a CD player, a DVD player, a Blu-ray Disc player, a personal media device, a portable media player, an iPod®, a Zoom Player, a laptop computer, a palmtop computer, a smart phone, a cell phone, a mobile phone, an mp3 player, a digital audio recorder, a digital video recorder, an IBM-type personal computer (PC) having an operating system such as Microsoft Windows®, an Apple® computer having an operating system such as MAC-OS, hardware having a JAVA-OS operating system, and a Sun Microsystems Workstation having a UNIX operating system.

“Web browser” means any software program which can display text, graphics, or both, from Web pages on Web sites. Examples of a Web browser include without limitation Mozilla Firefox® and Microsoft Internet Explorer®.

“Web page” means any documents written in mark-up language including without limitation HTML (hypertext mark-up language) or VRML (virtual reality modeling language), dynamic HTML, XML (extended mark-up language) or related computer languages thereof, as well as to any collection of such documents reachable through one specific Internet address or at one specific Web site, or any document obtainable through a particular URL (Uniform Resource Locator).

“Web server” refers to a computer or other electronic device which is capable of serving at least one Web page to a Web browser. An example of a Web server is a Yahoo® Web server.

“Web site” means at least one Web page, and more commonly a plurality of Web pages, virtually coupled to form a coherent group.

The various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present method and system provides a mechanism for linking user accounts that are split into multiple entities. In one embodiment, those entities include advertisers, publishers and agencies.

According to one embodiment, a computer-implemented method comprises:
receiving a link request from a first user having a first user account, the link request containing a username of a second user having a second user account;
sending the link request to the second user account;
receiving a response from the second user, the response being an approval response or a denial response;
linking the first user account and the second user account upon receiving the approval response; and
allowing the first user and the second user to share revenue based on performance of the first user and/or the second user.

According to one embodiment, the present mechanism for linking user accounts employs a layered, self-positioning panel (also referred to as Panel herein) that appears in a web browser served by Ad Server. This lightweight Panel is added to a web page by inserting a small snippet of code in the HTML of the web page. The Panel can be specifically targeted for a campaign-creating user while the user creates the campaign.

Advertisers sign up for a free account and create ads and content as well as campaigns. Advertisers typically fund their campaigns to promote their products and services. Advertisers can also become a publisher by simply linking their website to their user account. This enables advertisers to access various publisher features such as revenue share for ads that appear on their own website. Advertisers can also link directly with independent publishers, pending the publishers' approval. The linking to independent publishers can be done via a direct ‘link to’ option available to the advertisers.

According to one embodiment, four types of publisher accounts are served by the present user account linking mechanism. The main feature difference among these four types is in the self-serve features and a revenue share model from network advertising. Publishers' account includes pre-paid self-serve (House) impressions (except the free base account) and have a ‘link to’ option to directly link advertisers, pending the advertisers' approval.

Agency account is a full-feathered reseller account. Unlike standard advertiser and publisher accounts, agency account has the capability to add other user accounts including advertiser and publisher accounts and create a ‘sub-network’ of users. The features and information of advertiser and publisher accounts that the agency added are available to all clients.

Account linking and managing in an agency account is handled in the same manner as publisher and advertiser accounts. An agency account is provided with a management tool that facilitates management of multiple networks of clients (e.g., publishers and advertisers), account linking, and campaign management for their clients.

According to one embodiment, Ad targeting system (also referred to as Ad system) is provided with a permission-driven mechanism. This system allows advertisers to direct target specific sections of a selected publisher's website with a permission from the publisher.

For example, an advertiser having an account in the Ad system searches for another user who is a publisher for hosting their advertisements. Upon finding a desired ‘publisher’, the advertiser sends a link request through the Ad system. The publisher gets notified of the link request accompanied by an optional message. Upon the publisher's marking for an approval via the Ad system, the advertiser can ‘access’ to a specific Panel of the publisher's web page by the present account linking mechanism. After successful linking to the publisher, the advertiser runs a Network-Linked campaign directly onto the shared Panel(s).

According to another embodiment, a link request is initiated by a publisher to an advertiser. The publisher searches for an appropriate advertiser and sends the link request through the Ad system. With the advertiser's approval of the link request, the publisher and the advertiser share Panels for publishing the advertiser-provided ads. In this case, the publisher is allowed to setup and run a campaign on behalf of the advertiser.

This publisher-initiated account linking is particularly beneficial for a small to midsized publishers who self-source advertisements and desire to have a negotiation power for independent pricing with advertisers. A House-Linked campaign catered to self-advertising allows the publisher to directly control and manage their ads on their own website.

According to one embodiment, an advertiser and a publisher is linked based on a permission to share a panel of a web page. In one embodiment, the account linking between the advertiser and the publisher is implemented in a ‘mesh’ structure; many advertisers can link to one publisher and likewise many publishers can link to one advertiser.

The present account linking and management system provides a fine-grained permission at the ad(s) and content level, allowing highly targeted serving, accessibility, and control of the ad(s) and content on the publisher's web site.

According to one embodiment, user accounts include a reseller (agency) account with management controls for all managed advertiser and publisher accounts.

Agency-managed publisher accounts have the ability to separately manage their own private network of advertisers. Regular publishers can also manage their own private advertiser network.

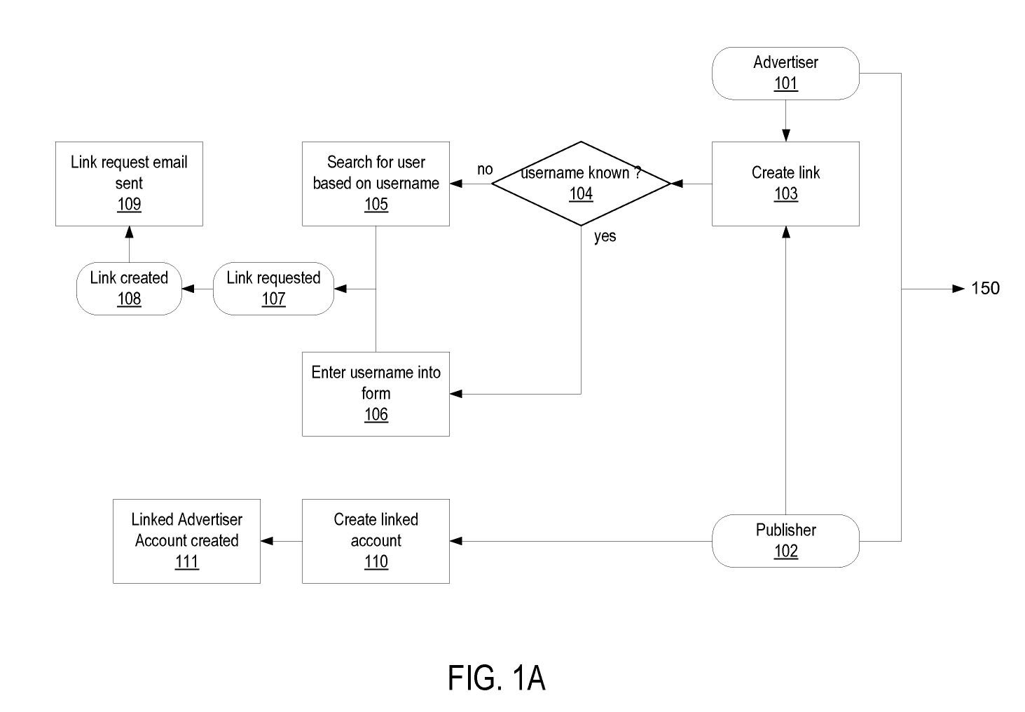

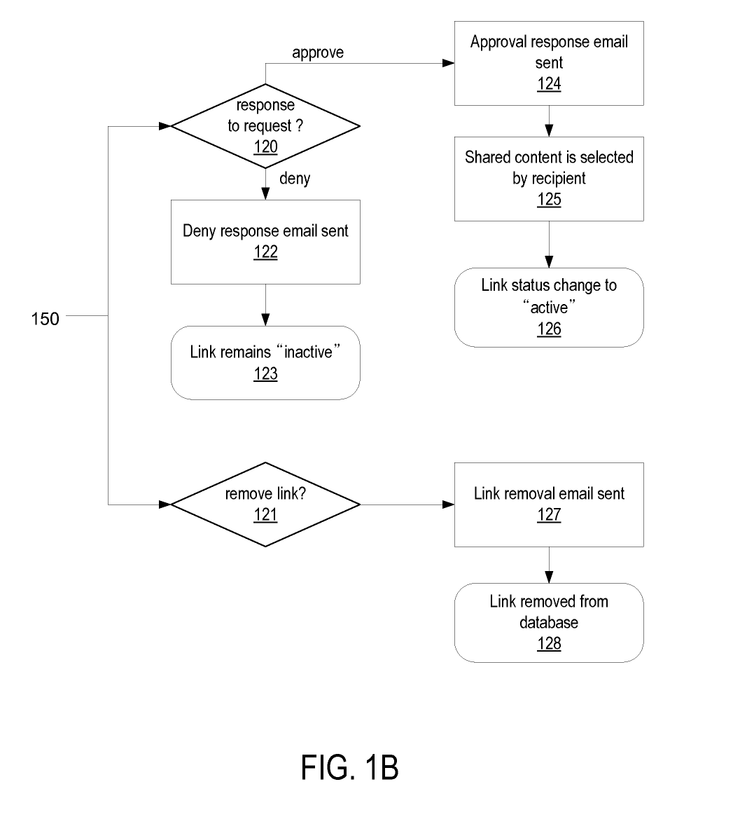

FIGS. 1A-1B illustrate a flow chart of an exemplary account linking process, according to one embodiment. Either advertiser 101 or publisher 102 can initiate account linking The request for account linking is received (103) and checked for the user name (104). If the user name is not known, the user name is searched in the database (105), otherwise the requester is given a form to enter username (106). The link is made (107) and the link between the requester and the account the requester requested to link (108), and the link request is sent to the requested user account (109). The link request may be an email, a text message, or a notification through the Ad Server.

Publisher 102 can separately request to create a linked account (110) and the linked advertiser account is created (111).

The advertiser 101 or publisher 102′s request is sent to the requested user account. If the request is approved (120), an approval response email is sent back to the requester (124), share account is selected by the recipient (125), and the link status changes to “active” (126). If the request denies the link request (120), a deny response email is sent (122), and the link remains “inactive” (123). If the link request is to remove link (121), a link removal email is sent (127), and the link is removed from the user database (128).

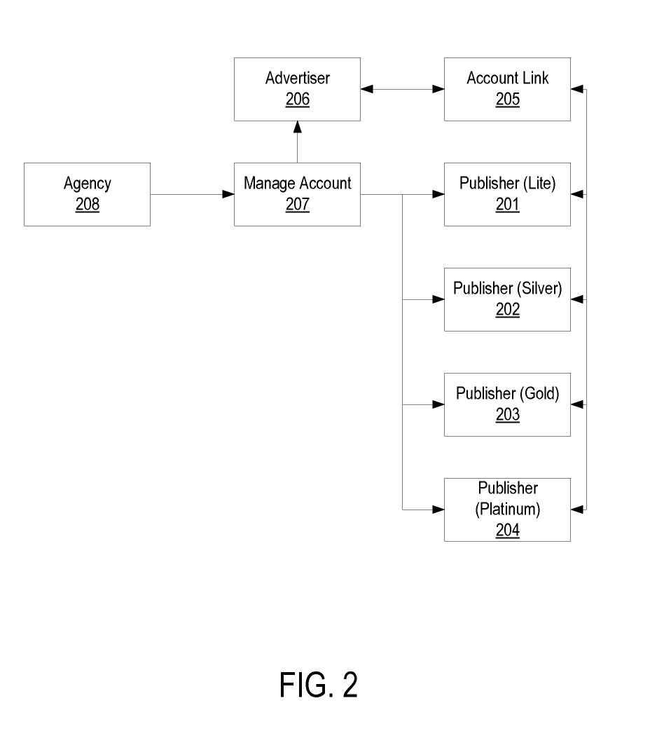

FIG. 2 illustrates exemplary account types and linking structure, according to one embodiment. In one embodiment, publisher's accounts are ranked based the number of user base, traffic, popularity, etc, for example, lite 201, silver 202, gold 203, and platinum 204. Publisher accounts 201-204 are linked to advertiser accounts 206 via 205 through the link request and approval process of FIG. 1. Agency accounts 208 can link to publisher accounts 201-204 and/or advertiser accounts 206 and manage them (207).

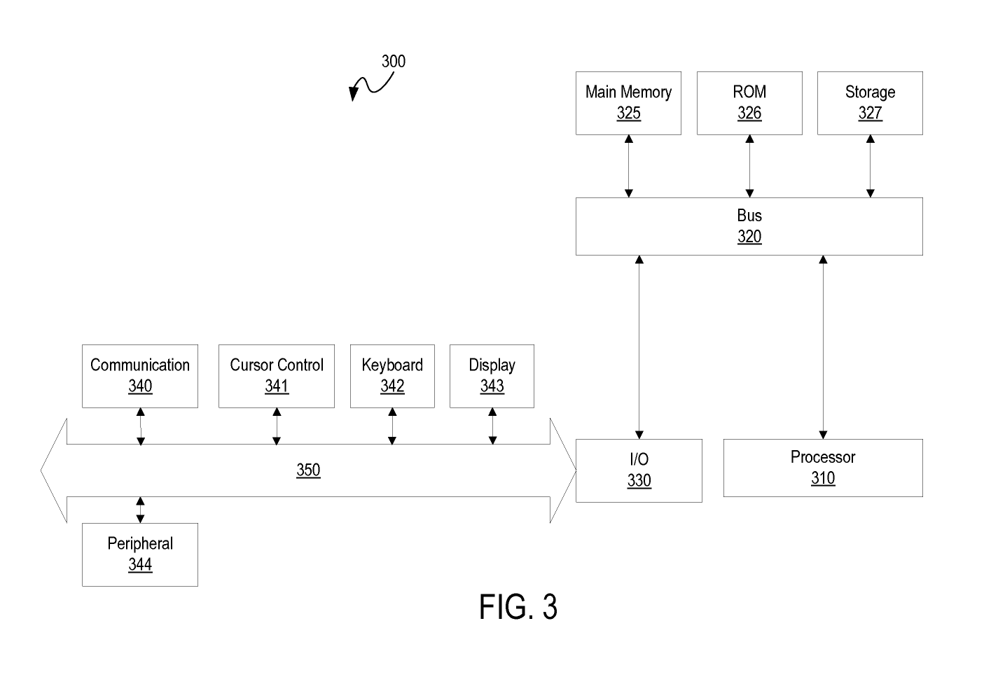

FIG. 3 illustrates an exemplary computer architecture 300 for use with the present system, according to one embodiment. The computer architecture 300 may be used to implement the present account management and linking system. One embodiment of the architecture 300 comprises a system bus 320 for communicating information, and a processor 310 coupled to the bus 320 for processing information. The architecture 300 further comprises a random access memory (RAM) or other dynamic storage device 325 (referred to herein as main memory), coupled to the bus 320 for storing information and instructions to be executed by the processor 310. Main memory 325 also may be used for storing temporary variables or other intermediate information during execution of instructions by the processor 310. The architecture 300 also may include a read only memory (ROM) and/or other static storage device 326 coupled to the bus 320 for storing static information and instructions used by the processor 310.

A data storage device 327 such as a flash memory, a magnetic disk or optical disc and its corresponding drive may also be coupled to the computer system architecture 300 for storing information and instructions. The architecture 300 can also be coupled to a second I/O bus 350 via an I/O interface 330. A plurality of I/O devices may be coupled to the I/O bus 350, including a display device 343, an input device (e.g., an alphanumeric input device 342 and/or a cursor control device 341).

The communication device 340 allows for access to other computers (servers or clients) via a network. The communication device 340 may comprise a modem, a network interface card, a wireless network interface or other well known interface device, such as those used for coupling to Ethernet, token ring, or other types of networks.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments of the invention also relate to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A method and system for managing and linking user accounts has been described. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

We claim:

1. A computer-implemented method, comprising:
receiving a link request from a first user having a first user account, the link request containing a username of a second user having a second user account;
sending the link request to the second user account;
receiving a response from the second user, the response being an approval response or a denial response;
linking the first user account and the second user account upon receiving the approval response; and
allowing the first user and the second user to share access to web pages, content, ads and/or revenue based on performance of the first user and/or the second user.

2. The computer-implemented method of claim 1, wherein the first user is a publisher hosting a website and the second user is an advertiser.

3. The computer-implemented method of claim 1, wherein the first user is an advertiser and the second user is a publisher hosting a website.

4. The computer-implemented method of claim 1, wherein the first user is an agency and the second user is an advertiser.

5. The computer-implemented method of claim 1, wherein the first user is an agency and the second user is a publisher hosting a website.

6. The computer-implemented method of claim 1, wherein the first user is an advertiser and the second user is an agency.

7. The computer-implemented method of claim 1, wherein the first user is a publisher hosting a website and the second user is an agency.

8. The computer-implemented method of claim 1, wherein the link request is sent to the second user account via an email, a text message, or a notification.

9. The computer-implemented method of claim 1 further comprising receiving a link removal request and removing the link between the first user account and the second user account.

10. A non-transitory computer readable medium having stored thereon a plurality of instructions, sand plurality of instructions when executed by a computer, cause said computer to perform:
receiving a link request from a first user having a first user account, the link request containing a username of a second user having a second user account;
sending the link request to the second user account;
receiving a response from the second user, the response being an approval response or a denial response;
linking the first user account and the second user account upon receiving the approval response; and
allowing the first user and the second user to share access to web pages, content, ads and/or revenue based on performance of the first user and/or the second user.

11. The non-transitory computer readable medium claim 10, wherein the first user is a publisher hosting a website and the second user is an advertiser.

12. The non-transitory computer readable medium claim 10, wherein the first user is an advertiser and the second user is a publisher hosting a website.

13. The non-transitory computer readable medium claim 10, wherein the first user is an agency and the second user is an advertiser.

14. The non-transitory computer readable medium claim 10, wherein the first user is an agency and the second user is a publisher hosting a website.

15. The non-transitory computer readable medium claim 10, wherein the first user is an advertiser and the second user is an agency.

16. The non-transitory computer readable medium claim 10, wherein the first user is a publisher hosting a website and the second user is an agency.

17. The non-transitory computer readable medium claim 10, wherein the link request is sent to the second user account via an email, a text message, or a notification.

18. The non-transitory computer readable medium claim 10, wherein the plurality of instructions cause the computer to further perform receiving a link removal request and removing the link between the first user account and the second user account.
